(19) United States
(12) Patent Application Publication
(10) Pub. No.: US 2006/0065737 A1
(43) Pub. Date: Mar. 30, 2006

(54) Holding apparatus

(76) Inventor: Robert W. Stuckel, Arlington Heights, IL (US)

Correspondence Address: Pauley Petersen & Erickson, Suite 365, 2800 West Higgins Road, Hoffman Estates, IL, 60195, US

(21) Appl. No.: 11/239,582

(22) Filed: Sep. 28, 2005

Related U.S. Application Data
(60) Provisional application No. 60/614,653, filed on Sep. 30, 2004.

(51) Int. Cl. G06K 13/00

(52) U.S. Cl. 235/475

(57) ABSTRACT

A holding apparatus for fixing the position of at least one card, such as a business card or another similar piece of sheet material. One or more holding assemblies are rotatably mounted with respect to a base. Each holding assembly has holding members secured with respect to adjacent holding members. Each holding member has at least one support element that is used to fix the position of the card with respect to the holding member. The holding apparatus of this invention can be used to rotatably display multiple cards or other similar pieces of sheet materials.

### BACKGROUND OF THE INVENTION

1. Field of the Invention

This invention relates generally to a device for organizing information, such as business contact information, in an easily visible manner and, more particularly, to a tower or elongated structure for securing and organizing business cards or other similar documents.

2. Discussion of Related Art

Paper clips and alligator clips have been attached to wires, rods or other elongated members to hold note cards, business cards and the like. Other wallet type devices have been used to hold and display business cards and photographs. A rotational apparatus, such as offered by ROLODEX™ machines, are known for holding and displaying business cards and other informational note cards.

### SUMMARY OF THE INVENTION

It is one object of this invention to provide a holding apparatus that can be used to display one or more business cards, notes, photographs or other similar sheet materials.

The above and other objects of this invention are accomplished with a holding assembly that is rotatably mounted with respect to a base. The holding assembly can include two or more holding members, each of which is secured with respect to an adjacent holding member.

In one embodiment of this invention, each holding member is formed by an elongated member that has two side portions, preferably but not necessarily positioned at an angle with respect to each other.

Each holding member has at least one support element for supporting the card, the note, the photograph and/or the other sheet material.

As used throughout this specification and in the claims, the term card, the term note and the term sheet material are intended to be interchangeable with each other and include other similarly shaped materials.

In one embodiment of this invention, each holding member has a plurality of the support elements, which can be arranged in a general linear fashion or any other suitable non-linear fashion. Each support element can be used to detachably hold or attach the card with respect to the holding member.

In certain embodiments of this invention, the support element includes a spring element, a spring clip, a holder and/or any other suitable mechanical device that can be used to support the card in a fixed but detachable position with respect to the holding member. In some embodiments of this invention, the support element is integrated with the holding member, such as through a metal stamping process or an injection molding process.

The holding members are fixed in position with respect to each other. In one embodiment of this invention, a hub is used to connect the holding members with respect to each other. The hub can be rotated with respect to the base, so that the mounted cards can be rotatably displayed. A rotator can be used to rotate the holding members with respect to the base.

In some embodiments of this invention, the base can form one or more receptacles, such as for accepting or receiving a stack of the cards. The holding apparatus of this invention can be used to form a tower shaped structure that holds the cards which can be rotatably displayed, thus making it convenient for a user to quickly see or scan the cards being displayed.

In another embodiment of this invention, two or more tower structures can be rotatably mounted with respect to the same base. The two holding assemblies can be mechanically linked so that moving and/or rotating one moves and/or rotates the other.

The holding apparatus of this invention can be sized and shaped to hold any desired number of cards or other similar materials. The rotational feature allows a user to quickly scan and identify information.

### BRIEF DESCRIPTION OF THE DRAWINGS

FIG. 1 is a front view of a card holder, according to one preferred embodiment of this invention;

FIG. 2 is a sectional top view of the card holder, as shown in FIG. 1, taken along line A-A;

FIG. 3 is a side view of a holding member, according to another preferred embodiment of this invention;

FIG. 4 is a front view of the holding member shown in FIG. 3;

FIG. 5 is a side view, opposite the side view shown in FIG. 3, of the holding member shown in FIG. 3;

FIG. 6 is a top view of the holding member shown in FIG. 3;

FIG. 7 is a side view of a top hub, according to one preferred embodiment of this invention;

FIG. 8 is a bottom view of an upper hub, as shown in FIG. 7;

FIG. 9 is a top view of a lower hub, according to one preferred embodiment of this invention;

FIG. 10 is a front view of the lower hub, as shown in FIG. 9;

FIG. 11 is a side view of an axle, according to one preferred embodiment of this invention;

FIG. 12 is a top view of an axle, as shown in FIG. 11;

FIG. 13 is a bottom view of the axle, as shown in FIG. 11;

FIG. 14 is a top view of a base of the card holder, according to one preferred embodiment of this invention;

FIG. 15 is a front view of the base, as shown in FIG. 14;

FIG. 16 is a top view of a base of the card holder, according to another preferred embodiment of this invention;

FIG. 17 is a front view of the base, as shown in FIG. 16;

FIG. 18 is a front view of a card holder holding a plurality of cards, according to one preferred embodiment of this invention;

FIG. 19 is a sectional top view of the business card tower, as shown in FIG. 18, taken along line B-B;

FIG. 20 is a front view of a card holder holding a plurality of cards, according to another preferred embodiment of this invention;

FIG. 21 is a sectional top view of the card holder, as shown in FIG. 20, taken along line C-C;

FIG. 22 is a top view of a lower rotator plate, according to one preferred embodiment of this invention;

FIG. 23 is a top view of a bottom portion of a base, according to one preferred embodiment of this invention;

FIG. 24 is a side view of the bottom portion, as shown in FIG. 23;

FIG. 25 is a top view of a cover portion of a base, according to one preferred embodiment of this invention;

FIG. 26 is a side view of the cover portion, as shown in FIG. 25;

FIG. 27 is a front view of a card holder having two holding assemblies mechanically linked with respect to each other, according to one preferred embodiment of this invention; and

FIG. 28 is a sectional top view of a card holder having two holding assemblies mechanically linked with respect to each other, according to another preferred embodiment of this invention.

### DETAILED DESCRIPTION OF THE INVENTION

This invention provides a card holder, such as a business card holder which can have an overall shape of a tower. The card holder includes a holding assembly comprised of a plurality of connected holding members each preferably having a plurality of support elements for securing or holding cards, such as business cards or other similarly shaped materials, in an easily visible configuration. It is apparent to those skilled in the art that the vertical structure or tower of this invention can be varied in size and shape, and can be used to hold or secure notes or other information or objects in addition to or in lieu of business cards.

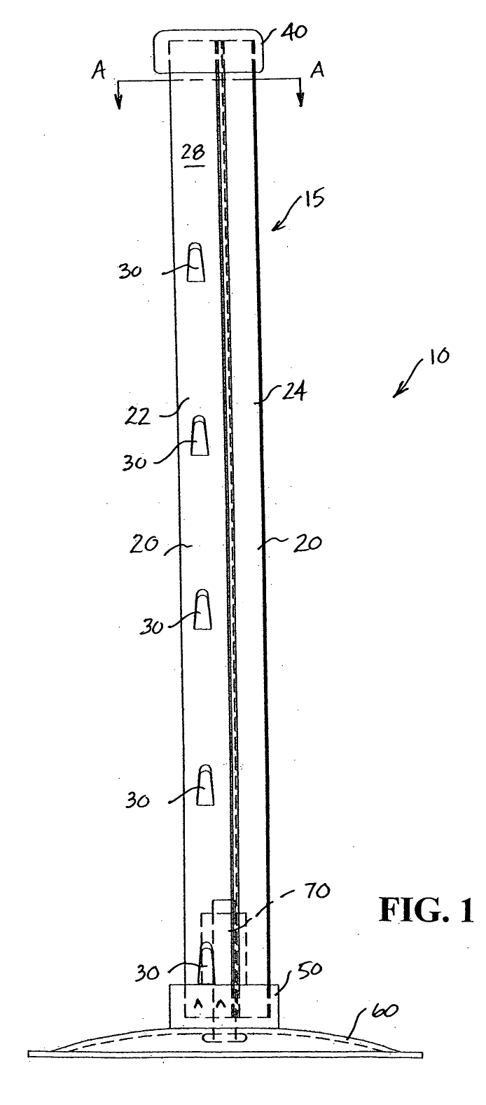

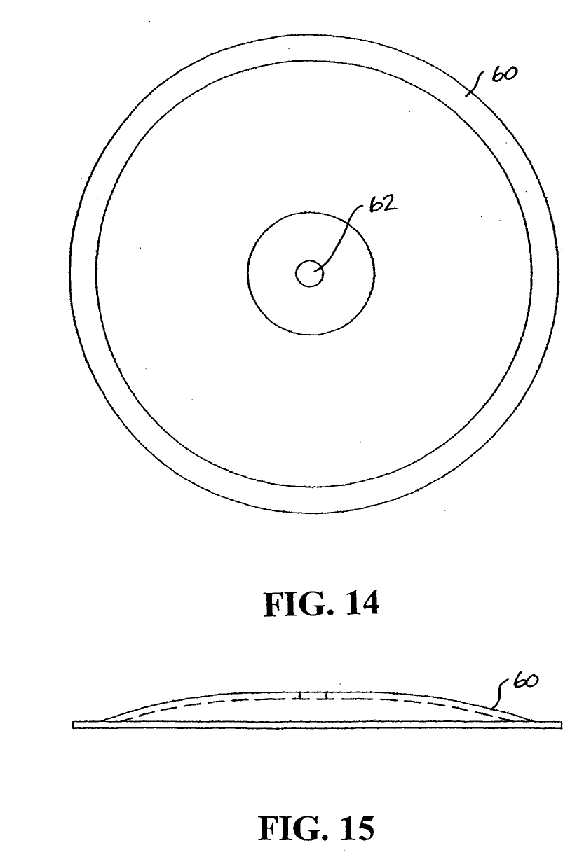

Referring to FIGS. 1-19, a card holder 10 includes a holding assembly 15. Holding assembly 15 comprises a plurality of holding members 20, preferably but not necessarily generally positioned in an upright or vertical configuration when in use. Holding members 20 are preferably secured, connected to, attached to and/or integrated with adjacent holding members 20 to form holding assembly 15, using any suitable connector, such as a welding and/or a crimping process. In one embodiment, holding members 20 are secured at an upper edge portion 21 and a lower edge portion 23, using an upper hub and a lower hub, respectively, such as shown in FIG. 1 and discussed in greater detail in this specification and in the claims.

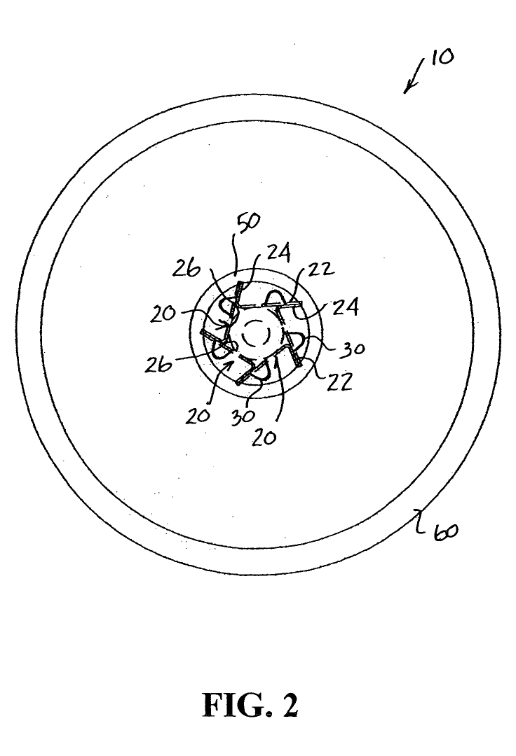

Each holding member 20 includes a first side portion 22 and a second side portion 24 preferably but not necessarily bent or angled with respect to first side portion 22, for example to form a generally “L” or “V” shaped cross section of holding member 20, as shown for example in FIGS. 2 and 6. As shown in FIG. 6, second side portion 24 is bent at an angle α with respect to first side portion 22. In one embodiment, angle α is preferably 90° or less. However, in certain embodiments of this invention, angle α may be greater than 90°. As shown in FIG. 2, a portion of a surface 26 of each holding member 20 contacts surfaces 26 of adjacent holding members 20 to form a generally polygonal cross-sectional shaped holding assembly 15. It is apparent that holding assembly 15 may have any desired general cross-sectional shape and/or size, depending upon the number, dimensions and/or shape of holding members 20 and/or the configuration of holding members 20.

Holding member 20 is preferably made of a suitable material, such as a metal and/or a polymer, that can be easily shaped or molded into a desired shape or configuration. It is apparent that other suitable materials, such as composite, metal, plastic, polymer, wood, alloy or other non-metal materials can be used to make or form holding member 20. In one embodiment, each holding member 20 includes or forms at least one support element, such as a spring clip 30, that extends from a surface 28 of first side portion 22, such as for holding or securing a business card or other suitable object in a fixed or mounted position, with respect to holding assembly 15. It is apparent to those skilled in the art that other suitable structures can be used as clips, holders and/or support elements to secure or hold objects, with respect to holding assembly 15. The support elements may be formed in or as a part of holding member 20, such as by punching and/or cutting methods, or can be integrated or molded with holding member 20.

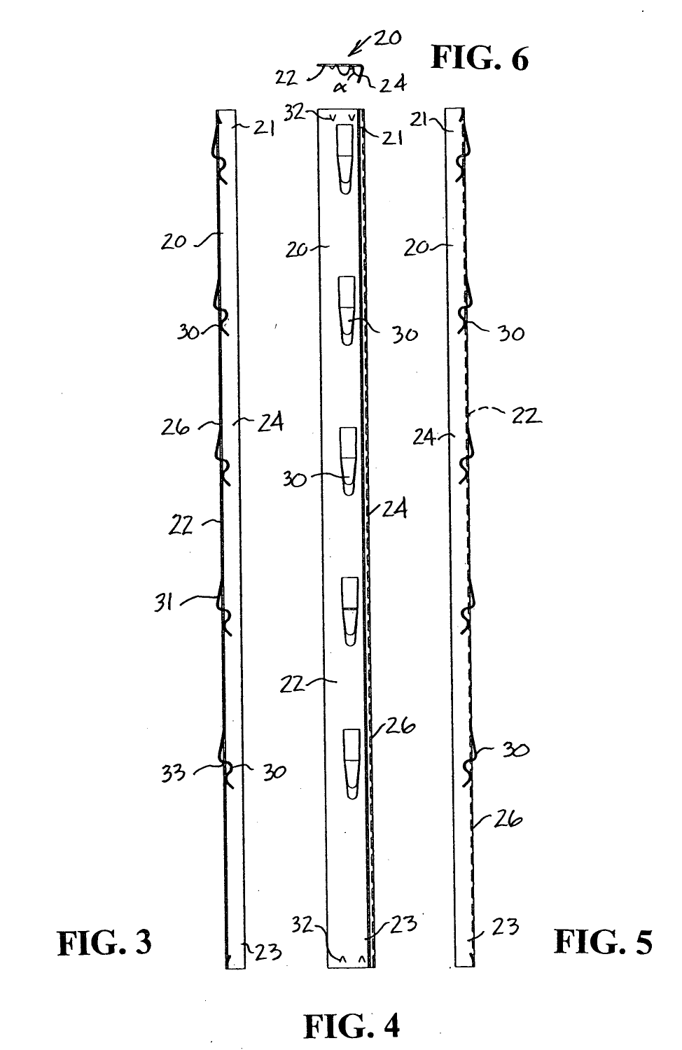

In one embodiment, holding member 20 includes a plurality of spring clips 30 positioned along a length of holding member 20, for example as shown in FIGS. 1 and 3-5. Preferably but not necessarily, spring clips 30 are evenly positioned along a length of holding member 20. However, in one preferred embodiment of this invention, spring clips 30 may be positioned at different spacing intervals, for example to accept business cards or other suitable objects having various dimensions. Alternatively or additionally, adjacent holding members 20 may include support elements spaced at the same or different spacing intervals along a length of the respective holding member 20. Each spring clip 30 can be positioned on holding member 20 to secure a top or upper edge portion and/or a bottom or lower edge portion of a business card. For example, as shown in FIGS. 3-5, spring clip 30 opens downwardly, such as to secure a top edge portion of a business card, a blank card or a note. Referring to FIG. 3, spring clip 30 includes a flat portion 31 that provides a spring action to secure the card or note against holding member 20. Spring clip 30 preferably but not necessarily includes a stop portion 33 that can interfere with business card 100 to properly position business card 100 with respect to holding member 20 and prevents further movement of business card 100. Spring clip 30 can be configured and positioned to open upwardly, such as to secure a bottom edge portion of the card or note, as shown in FIG. 1.

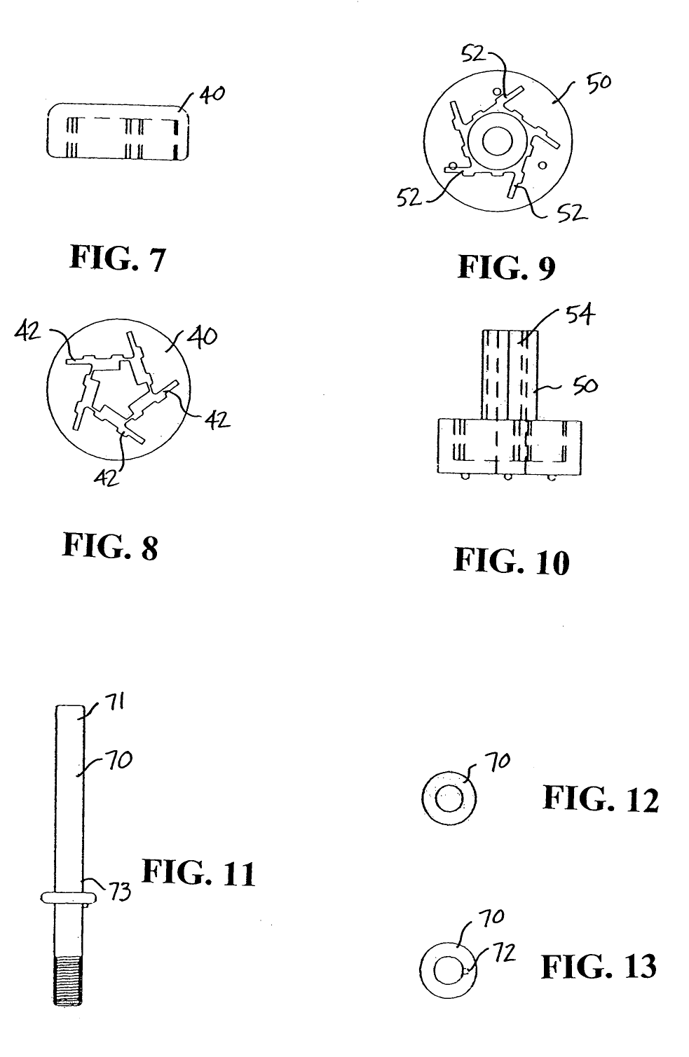

As shown in FIG. 4, holding member 20 preferably includes at least one barb, projection or clip 32 that extends from surface 26 and/or surface 28 of holding member 20 to secure holding member 20 within an upper hub 40, as shown in FIGS. 7 and 8, and/or a lower hub 50 of business card tower 10, as shown in FIGS. 9 and 10. For example, holding member 20 may form or include two projections 32 extending from front surface 28 at bottom end portion 23 of holding member 20, as shown in FIG. 4.

As shown in FIG. 8, upper hub 40 includes a plurality of grooves or channels 42 for accepting upper end portion 21 of holding member 20. Similarly, as shown in FIG. 9, lower hub 50 includes a plurality of grooves or channels 52 for accepting bottom end portion 23 of holding member 20. In one preferred embodiment of this invention, at least one of upper hub 40 and lower hub 50 is formed of an injection molded material. Upper hub 40 and/or lower hub 50 can be molded directly onto a respective end portion of the plurality of holding members 20 or can be formed and subsequently attached or connected to holding members 20 to form holding assembly 15.

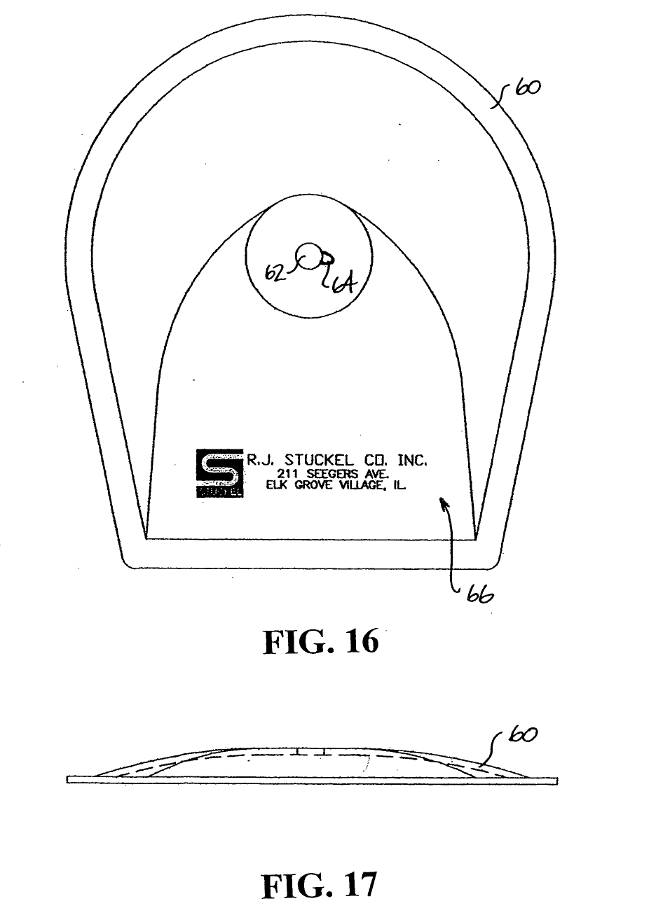

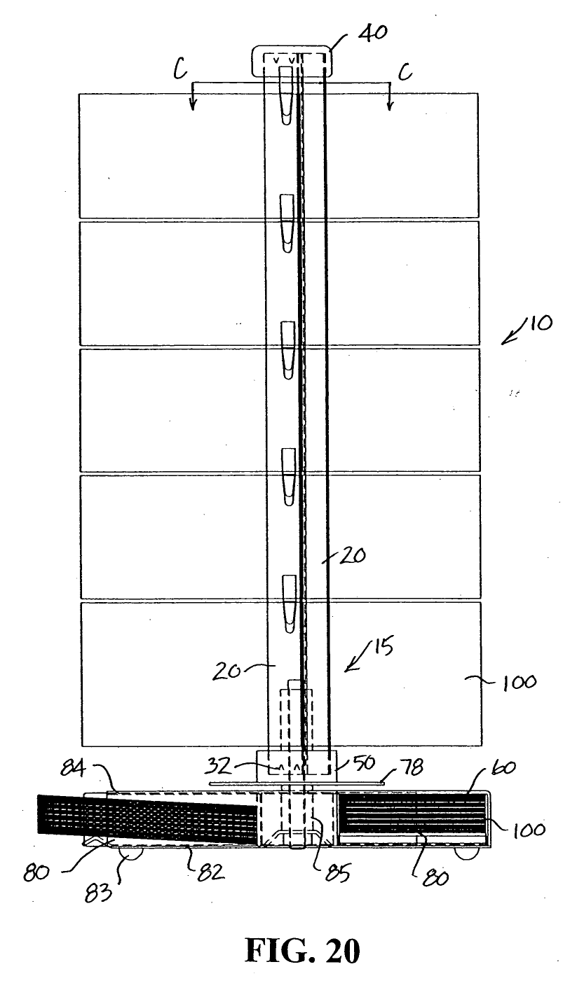

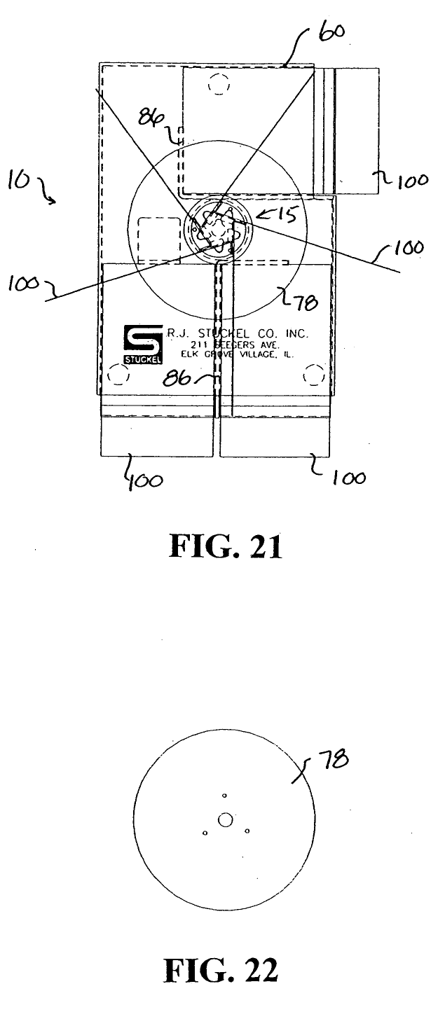

Referring to FIGS. 1, 2 and 14-17, card holder 10 includes a base 60. Base 60 forms an aperture 62 within which a shaft or an axle 70, as shown in FIGS. 11-13, is positioned and can be secured. With axle 70 secured to base 60, axle 70 is engageable with lower hub 50 to mount or connect holding assembly 15 with respect to base 60. In one preferred embodiment of this invention as shown in FIG. 10, lower hub 50 forms a bore 54 within which axle 70 is positionable. Preferably but not necessarily, axle 70 is positionable within bore 54 to allow holding assembly 15 to rotate about axle 70 with respect to base 60. Preferably but not necessarily, a tip portion 71 of axle 70 is enlarged, swelled or has a greater thickness or diameter than a thickness or diameter of a base portion 73 of axle 70. The increased thickness of tip portion 71 provides frictional interference and secures holding apparatus 15 to base 60 to prevent undesired disconnecting of holding apparatus 15 from base 60. Referring to FIGS. 13 and 16, in one embodiment of this invention axle 70 includes a projection 72 that interconnects or engages with a corresponding indentation or void 64 formed in base 60 to prevent or limit rotational movement of axle 70 with respect to base 60. Base 60 can include an area 66 for displaying text, a figure and/or signage, such as a firm or business name and/or logo, as shown in FIG. 16. A lower rotator 78 can be attached to holding assembly 15 and/or axle 70, such as shown in FIGS. 20-22. Lower rotator 78 can have any suitable size and/or shape.

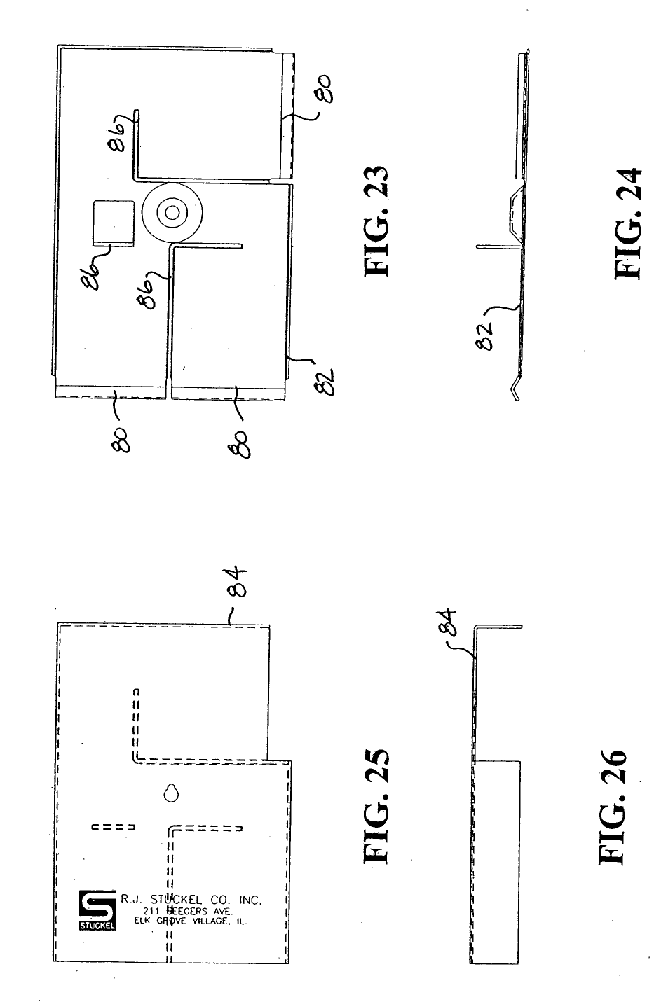

In one preferred embodiment of this invention, base 60 includes at least one and preferably a plurality of receptacles 80 for holding or storing business cards or other documents, as shown in FIGS. 20-26. Referring further to FIGS. 23-26, base 60 includes a bottom portion 82 and a cover portion 84 that attaches or connects to bottom portion 82 to form receptacles 80. As shown in FIG. 20, bottom portion 82 may include a plurality of footings 83 attached or connected to a surface of bottom portion 82. Footings 83 can provide stability to base 60 and prevent card holder 10 from scratching or damaging a surface on which card holder 10 is placed. Preferably, at least one divider 86 is connected to or integrated with bottom portion 82 and/or cover portion 84 to form receptacles 80 when base 60 is assembled. A spacer 85, such as shown in FIG. 20, can be connected to or integrated with bottom portion 82 and/or cover portion 84 for additional support when holding assembly 15 is mounted on base 60. Receptacle 80 can have suitable or desirable dimensions for holding or storing business cards, notes or other information or objects in addition to business cards.

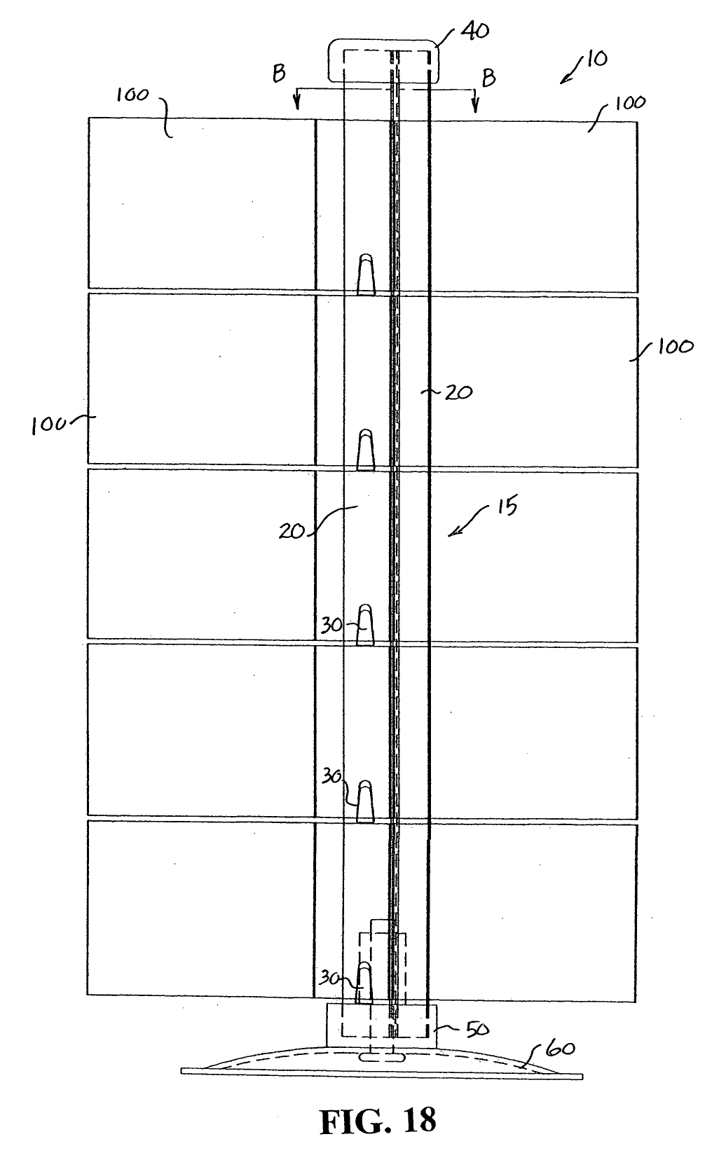

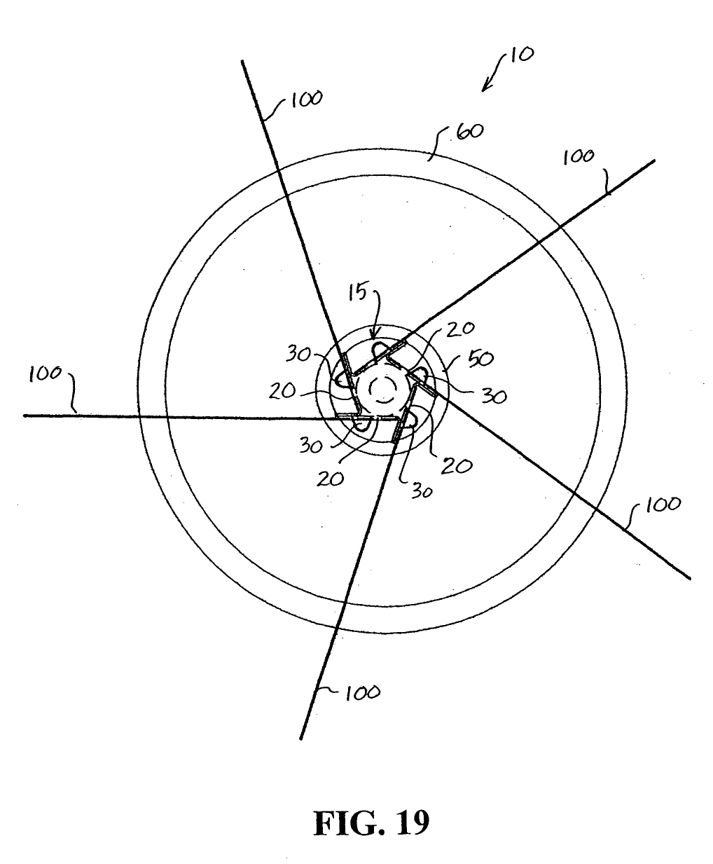

Thus, this invention provides a device for maintaining information in an organized, highly visible manner. The card holder of this invention includes a holding assembly including a plurality of holding members each preferably having a plurality of spaced apart supporting elements for securing business cards to the holding assembly. Preferably, the holding assembly is rotatably mounted to a base of the card holder, so that the holding assembly can be rotated to view different cards. Referring to FIGS. 18 and 19, the business card structure or tower of this invention secures a plurality of business cards 100 and/or card notes.

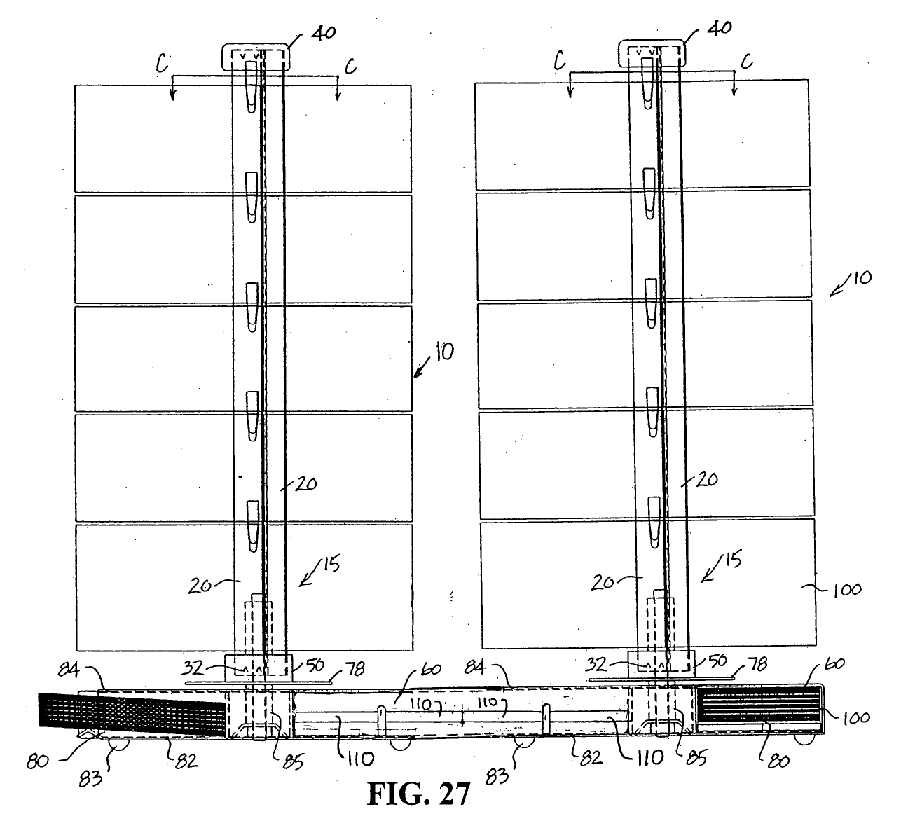

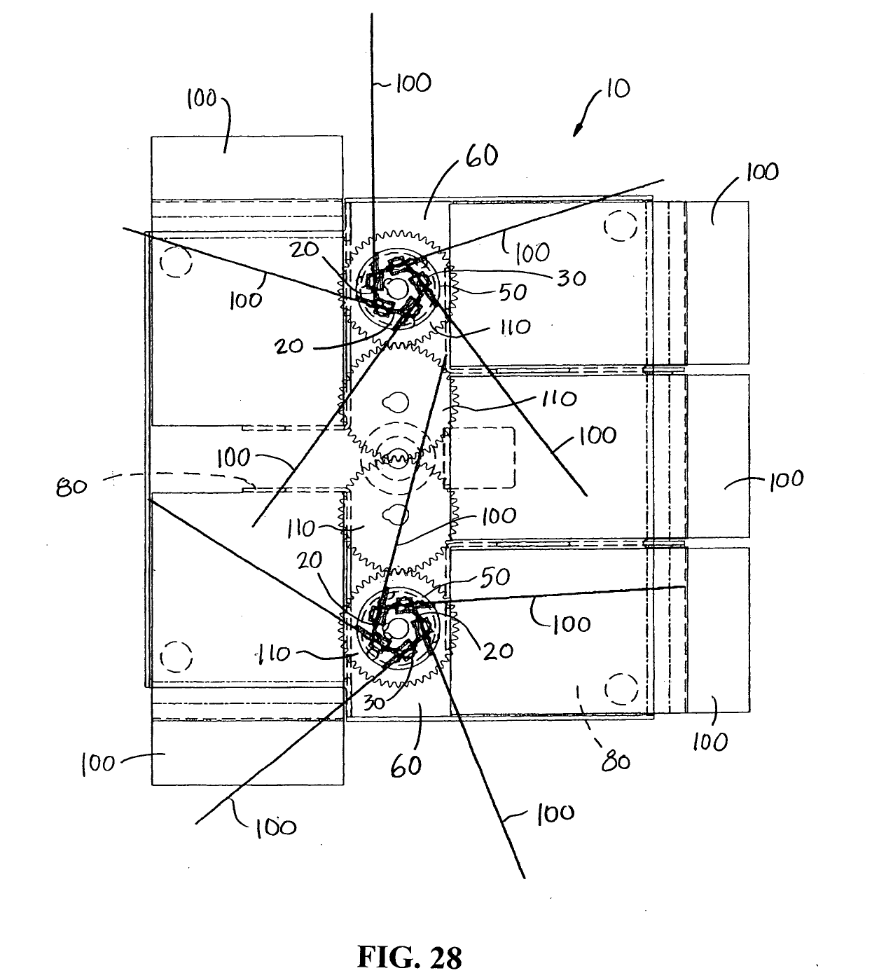

FIG. 27 shows a front view of two holding assemblies 15 each rotatably mounted with respect to base 60, according to one embodiment of this invention. FIG. 28 shows a sectional top view of two holding assemblies 15 each rotatably mounted with respect to base 60, according to another embodiment of this invention. According to the embodiments shown in FIGS. 27 and 28, the first holding assembly 15 can be independent of or mechanically linked to the second holding assembly 15. When mechanically linked together, as shown in FIGS. 27 and 28, moving and/or rotating one holding assembly 15 can move and/or rotate the second holding assembly 15. The mechanical link can be formed by at least one gear 110 such as shown in FIG. 27, a gear train of gears 110 such as shown in FIG. 28, a magnetic connection and/or any other suitable connection that mechanically links both holding assemblies 15.

This invention as illustratively disclosed in this specification, drawings and claims suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that this invention is susceptible to additional embodiments and that certain of the details described herein can be varied considerably without departing from the basic principles of this invention.

We claim:

1. An apparatus for holding at least one of a card, a note, and another sheet material, the apparatus comprising:
a holding assembly rotatably mounted with respect to a base, said holding assembly including a plurality of holding members each secured with respect to an adjacent holding member of said holding members, and each said holding member having a plurality of support elements for supporting the at least one of the card, the note and the sheet material.

2. The apparatus according to claim 1, wherein each said holding member comprises an elongated member having a first side portion positioned at an angle with respect to a second side portion.

3. The apparatus according to claim 2, wherein said support elements are positioned along at least one of said first side portion and said second side portion.

4. The apparatus according to claim 2, wherein each said first side portion is adjacent said second side portion of said adjacent holding member.

5. The apparatus according to claim 2, wherein said holding member has between 3 and 8 of said holding members.

6. The apparatus according to claim 1, wherein each said support element comprises at least one of a spring clip and a holder.

7. The apparatus according to claim 6, wherein said spring clip comprises a spring arm having one end portion fixed with respect to said holding member and a freely movable second end portion.

8. The apparatus according to claim 7, wherein said one end portion is integrated with said holding member.

9. The apparatus according to claim 1, wherein said holding members are mounted within a hub.

10. The apparatus according to claim 9, wherein said holding members are mounted within a second hub that is rotatably mounted with respect to said base.

11. The apparatus according to claim 10, wherein a shaft is engageable with said second hub.

12. The apparatus according to claim 11, wherein said shaft forms an interference fit with said second hub.

13. The apparatus according to claim 1, wherein a rotator is attached with respect to said holding members.

14. The apparatus according to claim 1, wherein said base forms at least one receptacle.

15. The apparatus according to claim 14, wherein said at least one receptacle is formed between a bottom portion and a cover portion of said base.

16. The apparatus according to claim 1, wherein a retainer is one of attached to and integrated with said base, and said retainer forms a contact surface that extends outward from said base.

17. The apparatus according to claim 1, wherein a second holding assembly is rotatably mounted with respect to said base.

18. The apparatus according to claim 17, wherein said second holding assembly is mechanically linked to said holding assembly.

19. The apparatus according to claim 18, wherein movement of said holding assembly causes movement of said second holding assembly.

20. The apparatus according to claim 18, wherein at least one gear mechanically links said holding assembly and said second holding assembly.
